(19) United States
(12) Patent Application Publication
(10) Pub. No.: US 2026/0034936 A1
(43) Pub. Date: Feb. 5, 2026

(54) FACIAL RECOGNITION BASED DIGITAL SIDE MIRROR CONTROL DEVICE AND METHOD

(71) Applicants: HYUNDAI MOTOR COMPANY, Seoul (KR); Kia Corporation, Seoul (KR)

(72) Inventors: Jongha WON, Gyeonggi-do (KR); Kyunghwan CHO, Gyeonggi-do (KR); Jongwook KIM, Gyeonggi-do (KR); Moonsub JIN, Gyeonggi-do (KR); Jiwon KIM, Gyeonggi-do (KR)

(21) Appl. No.: 19/286,925

(22) Filed: Jul. 31, 2025

(30) Foreign Application Priority Data
Aug. 1, 2024 (KR) 10-2024-0102460
May 8, 2025 (KR) 10-2025-0059536

(51) Int. Cl. B60R 1/072; B60R 1/12; G06T 7/73; G06V 10/74; G06V 10/82; G06V 20/59; G06V 40/16; G06V 40/20

(52) U.S. Cl. CPC B60R 1/072; B60R 1/12; G06T 7/73; G06V 10/761; G06V 10/82; G06V 20/597; G06V 40/171; G06V 40/172; G06V 40/20; B60R 2001/1215; G06T 2207/30201; G06T 2207/30268

(57) ABSTRACT

A facial recognition based digital side mirror control device includes a multi-spectral-based face detection module that detects the face of a driver in a vehicle, a face attribute detection module that detects a face attribute including the position and feature of the face and driver information on the basis of the detected face, using an artificial intelligence model, a module for determining whether a motion has been made that detects whether the driver is looking at a side mirror, and executes an algorithm only when it is determined that the driver is looking at the side mirror, and a side mirror adjustment module that adjusts the viewing angle of the side mirror on the basis of a change value whenever the face attribute including the position of the face of the driver looking at the side mirror changes.

### CROSS-REFERENCE TO RELATED APPLICATION

This application claims priority to and the benefit of Korean Patent Application No. 10-2024-0102460, filed with the Korean Intellectual Property Office on Aug. 1, 2024, and Korean Patent Application No. 10-2025-0059536, filed with the Korean Intellectual Property Office on May 8, 2025. The entire contents of the related applications are incorporated herein by reference.

### TECHNICAL FILED

The present disclosure relates to a facial recognition based digital side mirror control device and method which actively operate by recognizing a driver's face.

### BACKGROUND

Digital side mirrors may provide advantages over conventional side mirrors, such as wider viewing angle and clearer screen, but the digital side mirrors may feel unfamiliar, which may reduce usability.

For example, in conventional side mirrors, users may change the position of the head to change their viewing angle or scene in the side mirror. In contrast, in digital side mirrors, when users change the position of their head, a fixed screen may be displayed.

### SUMMARY

The present disclosure describes a facial recognition based digital side mirror control device and method capable of reducing a different feeling from conventional side mirrors.

The present disclosure describes a facial recognition based digital side mirror control device and method capable of being controlled by facial movements alone without requiring special additional operations even in an environment in which a user is driving in an existing automobile.

According to one aspect of the subject matter described in this application, a side mirror control device is configured to operation based on facial recognition. The side mirror control device includes one or more processors and one or more memory devices storing a program code configured to, based on being executed by the one or more processors, cause the side mirror control device to perform operations. The operations include detecting a face of a driver in a vehicle, detecting a face attribute including a position of the face, a feature of the face, and driver information using an artificial intelligence model, determining whether the driver is looking at a side mirror of the vehicle, executing an algorithm based on determining that the driver is looking at the side mirror, and adjusting at least one setting of the side mirror based on an attribute change of the face attribute, the attribute change including a position change of the position of the face of the driver looking at the side mirror.

Implementations according to this aspect can include one or more of the following features. For example, detecting the face attribute can include extracting the driver information including an age and a gender of the driver, using a trained deep learning model, extracting a feature vector of the face, using a trained deep learning model, extracting a landmark including eyes, a nose, and a mouth from information of the face of the driver, extracting a face angle based on the landmark, obtaining an image coordinate corresponding to the position of the face, and extracting a distance between a camera and the face based on a depth of the position of the face.

In some implementations, determining whether the driver is looking at the side mirror of the vehicle can include determining that the driver is looking at the side mirror of the vehicle based on the face angle being within a preset range that is set based on the face angle and a side mirror angle of the side mirror. In some examples, adjusting the at least one setting of the side mirror can include extracting an attribute change value including an angle change value of an angle between the face and the side mirror, processing an image of a screen to be displayed on the side mirror based on the attribute change value, and setting a side mirror adjustment sensitivity based on the driver information.

In some implementations, extracting the attribute change value can include calculating the angle change value based on an angle difference between (i) a first angle between the face and the side mirror at an initial position of the face and (ii) a second angle between the face and the side mirror at a current position of the face. In some examples, extracting the attribute change value further can include determining an adjustment value for an adjustment of the side mirror based on multiplying the angle difference by a weighting factor.

In some implementations, extracting the attribute change value further can include determining a plurality of weighting factors based on (i) a resolution each of a plurality of side mirrors of the vehicle and (ii) an angle of each of the plurality of side mirrors relative to the face, and determining an adjustment value for an adjustment of each of the plurality of side mirrors based on multiplying the angle difference corresponding to one of the plurality of side mirrors by a corresponding one of the plurality of weighting factors.

In some implementations, adjusting the at least one setting of the side mirror further can include adjusting a viewing angle of the side mirror based on the adjustment value and the side mirror adjustment sensitivity. In some examples, setting the side mirror adjustment sensitivity can include setting the side mirror adjustment sensitivity based on a sensitivity input provided through an infotainment system of the vehicle.

In some implementations, detecting the face attribute can include calculating a similarity between (i) the feature vector that is extracted using the trained deep learning model and (ii) one or more feature vectors that are pre-registered for one or more drivers, and identifying the driver based on the similarity.

According to another aspect, a side mirror control method is performed based on facial recognition by a computing device including a processor and a memory. The side mirror control method includes detecting a face of a driver in a vehicle, detecting a face attribute including a position of the face, a feature of the face, and driver information using an artificial intelligence model, determining whether the driver is looking at a side mirror of the vehicle, executing an algorithm based on determining that the driver is looking at the side mirror, and adjusting at least one setting of the side mirror based on an attribute change of the face attribute, the attribute change including a position change of the position of the face of the driver looking at the side mirror.

Implementations according to this aspect can include one or more of the following features. For example, detecting the face attribute can include extracting the driver information including an age and a gender of the driver, using a trained deep learning model, extracting a feature vector of the face, using a trained deep learning model, extracting a landmark including eyes, a nose, and a mouth from information of the face of the driver, extracting a face angle based on the landmark, obtaining an image coordinate corresponding to the position of the face, and extracting a distance between a camera and the face based on a depth of the position of the face.

In some implementations, determining whether the driver is looking at the side mirror of the vehicle can include determining that the driver is looking at the side mirror of the vehicle based on the face angle being within a preset range that is set based on the face angle and a side mirror angle of the side mirror. In some examples, adjusting the at least one setting of the side mirror can include extracting an attribute change value including an angle change value of an angle between the face and the side mirror, processing an image of a screen to be displayed on the side mirror based on the attribute change value, and setting a side mirror adjustment sensitivity based on the driver information.

In some implementations, extracting the attribute change value can include calculating the angle change value based on an angle difference between (i) a first angle between the face and the side mirror at an initial position of the face and (ii) a second angle between the face and the side mirror at a current position of the face. In some examples, extracting the attribute change value further can include determining an adjustment value for an adjustment of the side mirror based on multiplying the angle difference by a weighting factor.

In some implementations, extracting the attribute change value further can include determining a plurality of weighting factors based on (i) a resolution each of a plurality of side mirrors of the vehicle and (ii) an angle of each of the plurality of side mirrors relative to the face, and determining an adjustment value for an adjustment of each of the plurality of side mirrors based on multiplying the angle difference corresponding to one of the plurality of side mirrors by a corresponding one of the plurality of weighting factors.

In some implementations, adjusting the at least one setting of the side mirror further can include adjusting a viewing angle of the side mirror based on the adjustment value and the side mirror adjustment sensitivity. In some examples, setting the side mirror adjustment sensitivity can include setting the side mirror adjustment sensitivity based on a sensitivity input provided through an infotainment system of the vehicle.

In some implementations, detecting the face attribute can include calculating a similarity between (i) the feature vector that is extracted using the trained deep learning model and (ii) one or more feature vectors that are pre-registered for one or more drivers, and identifying the driver based on the similarity.

In some implementations, the facial recognition based digital side mirror control device and method can reduce user's unfamiliarity with a digital side mirror.

In some implementations, the facial recognition based digital side mirror control device and method can deliver a natural experience to a user without any special operation, in consideration of an environment in which the user is driving in an automobile.

In some implementations, the facial recognition based digital side mirror control device and method are operable at night.

In some implementations, the facial recognition based digital side mirror control device and method can prevent unnecessary confusion by naturally executing an algorithm only when a user intends to look at a side mirror.

In some implementations, the facial recognition based digital side mirror control device and method can set a sensitivity suitable for a user.

### BRIEF DESCRIPTION OF THE DRAWINGS

FIG. 1 schematically shows an example of a facial recognition based digital side mirror control system.

FIG. 2 is a flow chart of an example of a facial recognition based digital side mirror control device and method.

FIG. 3 is a block diagram of an example of a face attribute detection module.

FIG. 4 is a drawing for explaining an example of a facial recognition based digital side mirror control method.

FIG. 5 is a drawing for explaining an example of a module for determining whether a motion has been made.

FIGS. 6 to 8 are drawings for explaining an example of an attribute change value extractor.

FIGS. 9 and 10 are flow charts illustrating an example of an operation mechanism of a facial recognition based digital side mirror control method.

FIG. 11 is a drawing for explaining an example of an image processor.

FIG. 12 is a drawing for explaining an example of a computing device.

### DETAILED DESCRIPTION

Hereinafter, example implementations of the present disclosure will be described in detail with reference to the accompanying drawings such that those skilled in the art can easily implement them. As those skilled in the art would realize, the described implementations can be modified in various different ways, all without departing from the spirit or scope of the present disclosure.

Accordingly, the drawings and description are to be regarded as illustrative in nature and not restrictive. Like reference numerals designate like elements throughout the specification.

Throughout this specification, the term “unit” or “module”, the suffix “-or” or “-er”, or the like can refer to a unit for processing at least one function or operation that is described in this specification, which can be implemented with hardware or circuitry, software, or a combination of software and hardware or circuitry.

Hereinafter, example implementations of the present disclosure will be described with reference to the drawings.

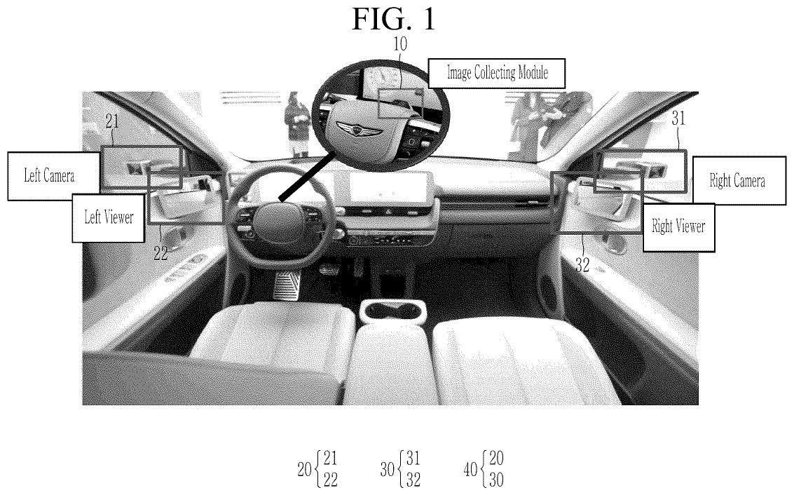

FIG. 1 schematically shows an example of a facial recognition based digital side mirror control system. The facial recognition based digital side mirror control system includes a facial recognition based digital side mirror control device.

FIG. 1 shows the hardware structure of the system. In some implementations, a digital side mirror 40 can have a structure including a left side mirror 20 and a right side mirror 30.

The digital side mirror 40 can include cameras 21 and 31 and viewers 22 and 32.

Referring to FIG. 1, the facial recognition based digital side mirror control system can include an image collecting module 10, the left camera 21, the right camera 31, the left viewer 22, and the right viewer 32.

The image collecting module 10 can be disposed at a position with a good view of the face of a user (e.g., near the steering wheel of a vehicle).

The image collecting module 10 can include an RGB-NIR (Near Infrared) image sensor to enable recognition both day and night, in consideration of a vehicle driving environment.

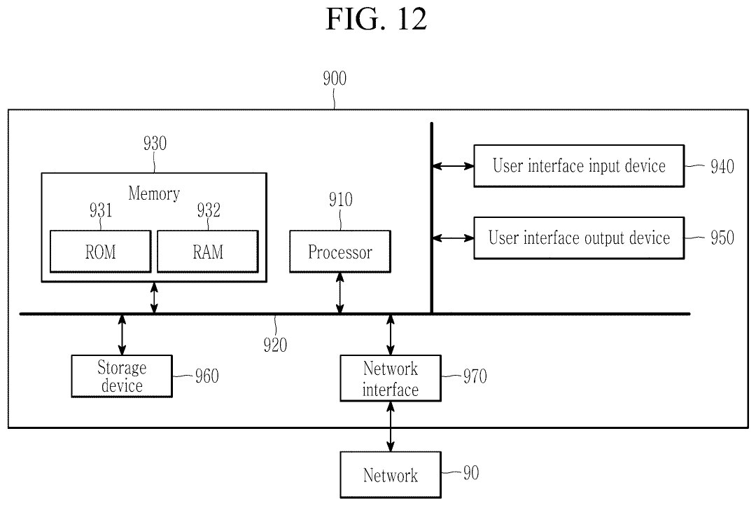

The facial recognition based digital side mirror control device according to the example implementation can be implemented with a computing device 900 (see FIG. 12) which is connected to the digital side mirror 40 through a network.

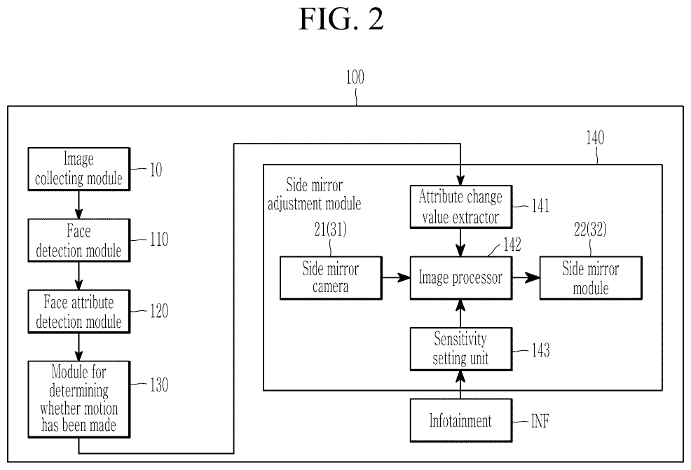

FIG. 2 is a block diagram of an example of a facial recognition based digital side mirror control device.

Referring to FIG. 2, a facial recognition based digital side mirror control device 100 can include an image collecting module 10, a face detection module 110, a face attribute detection module 120, a module 130 for determining whether a motion has been made, and a side mirror adjustment module 140.

The image collecting module 10 can include an RGB-NIR (Near Infrared) image sensor for collecting an image of the face of a user.

The face detection module 110 can detect the face of a driver in a vehicle on the basis of the collected image. The face detection module 110 can be implemented using a multi-spectral sensor, so as to be able to detect a face even in a dark night.

The face attribute detection module 120 can detect a face attribute including the position and feature of the face and driver information, based on the detected face, using an artificial intelligence model.

The face attribute detection module 120 can calculate the similarity of the extracted feature vector to a feature vector registered in advance for each driver.

The face attribute detection module 120 can identify the driver on the basis of the calculated similarity.

The module 130 for determining whether a motion has been made can detect whether the driver is looking at a side mirror.

The module 130 for determining whether a motion has been made can execute an algorithm only when it is determined that the driver is looking at a side mirror.

When the face angle falls within a specific angle range preset based on the face angle and the side mirror angle of a side mirror, the module 130 for determining whether a motion has been made can determine that the driver is looking at the side mirror.

Whenever the face attribute including the position of the face of the driver looking at the side mirror changes, the side mirror adjustment module 140 can adjust the viewing angle of the side mirror on the basis of the change value.

The side mirror adjustment module 140 can include an attribute change value extractor 141, an image processor 142, and a sensitivity setting unit 143.

The attribute change value extractor 141 can extract an attribute change value including an angle change value of the angle between the face and the side mirror.

The attribute change value extractor 141 can obtain an angle change value on the basis of the difference between a first angle between the face and the side mirror at the initial position of the face and a second angle between the face and the side mirror at the current position of the face.

The attribute change value extractor 141 can multiply the angle difference by a weight, thereby determining an adjustment value to be applied in the adjustment of the side mirror. For example, the weight is a weighing factor, or a numerical coefficient used in a calculation.

The attribute change value extractor 141 multiplies with different weights depending on a plurality of side mirrors and the angle between each of the plurality of side mirrors and the face.

The attribute change value extractor 141 can determine different weights on the basis of the resolution of each of the plurality of side mirrors and the angle of each side mirror to the face.

The image processor 142 can process an image of a screen which is displayed on the side mirror on the basis of the attribute change value.

The image processor 142 can adjust the viewing angle on the basis of the adjustment value and side mirror adjustment sensitivity.

The image processor 142 can receive an image of a screen from a side mirror camera 21 or 31, process the image, and output the processed image through a side mirror viewer 22 or 32.

The sensitivity setting unit 143 can set side mirror adjustment sensitivity based on the driver information.

The sensitivity setting unit 143 can set the adjustment sensitivity based on sensitivity which the driver has input in advance through infotainment INF of the vehicle.

The sensitivity setting unit 143 can provide the side mirror adjustment sensitivity to the image processor 142.

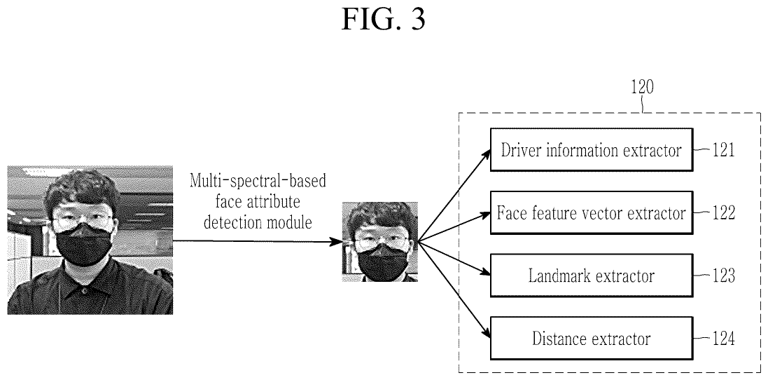

FIG. 3 is a block diagram of an example of the face attribute detection module.

The face attribute detection module 120 can include a driver information extractor 121, a face feature vector extractor 122, a landmark extractor 123, and a distance extractor 124.

The driver information extractor 121 can extract driver information including the age and gender of the driver, using a trained deep learning model.

The face feature vector extractor 122 can extract the feature vector of the face, using a trained deep learning model.

The landmark extractor 123 can extract a landmark including the eyes, nose, and mouth of the driver's face, and extract the face angle on the basis of the extracted landmark.

The distance extractor 124 can obtain the image coordinate based position of the face, and extract the distance between the camera and the face on the basis of the depth of the position.

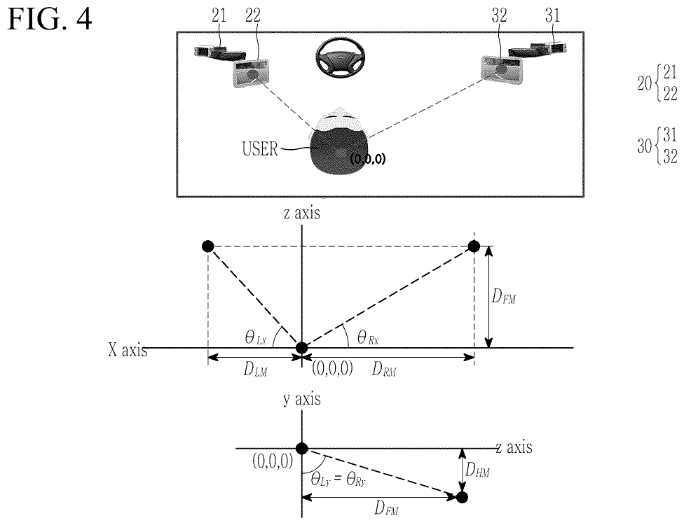

FIG. 4 is a drawing for explaining an example of a facial recognition based digital side mirror control method. The facial recognition based digital side mirror control method can be performed through the facial recognition based digital side mirror control device 100 of FIG. 2.

In FIG. 4, the facial recognition based digital side mirror control device 100 fixes the initial face position when the driver is seated in the seat to a default value (0, 0, 0).

The facial recognition based digital side mirror control device 100 can define the distance of the left side mirror 20 of the vehicle from the initial face position of the driver and the distance of the right side mirror 30 of the vehicle from the initial face position of the driver as D_{LM} and D_{RM}, respectively, and define the vertical distance of a side mirror from the initial face position of the driver and the height of a side mirror as D_{FM} and D_{HM}, respectively.

The facial recognition based digital side mirror control device 100 can define the initial angles between the face position of the driver (USER) and the left and right side mirrors as θ_{Lx}, θ_{Rx}, θ_{Ly}, and θ_{Ry}.

$$Here , {θ}_{Lx} can be {tan}^{- 1} ( \frac{{D}_{FM}}{{D}_{LM}} ) , {θ}_{Rx} can be {tan}^{- 1} ( \frac{{D}_{FM}}{{D}_{RM}} ) , and {θ}_{Ly} and {θ}_{Ry} can be {tan}^{- 1} ( \frac{{D}_{FM}}{{D}_{HM}} ) .$$

For example, the facial recognition based digital side mirror control device 100 can obtain a motion weight corresponding to the difference between the initial angle θ_{Lx} and the changed angle θ_{Lx}′ when the driver's face moves from side to side, and adjust the screen or viewing angle of the left side mirror by the obtained weight.

This is based on the principle that the angle of incidence and the angle of reflection of the mirror are the same, and the moving sensitivity can be adjusted according to the sensitivity which is adjusted.

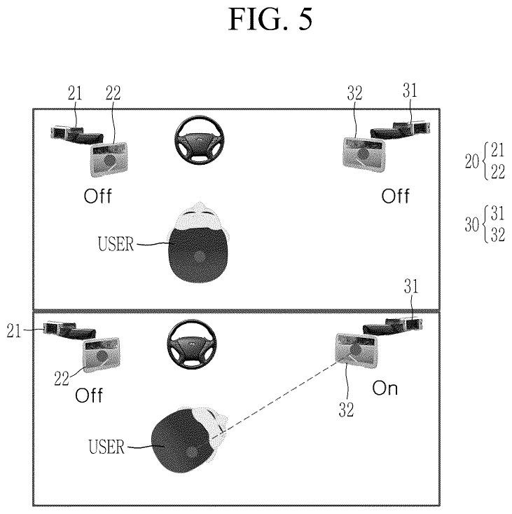

FIG. 5 is a drawing for explaining an example of a module for determining whether a motion has been made.

Considering a situation in which the user is driving the vehicle, it may be distracting if the algorithm is executed when the user did not intend for the algorithm to be executed. Therefore, the facial recognition based digital side mirror control device 100 grasps the intention of the user, and performs the algorithm operation only when the user wants it.

In FIG. 5, when it is determined that the user is looking at a side mirror, the facial recognition based digital side mirror control device 100 can operate only the corresponding side mirror by the algorithm.

The facial recognition based digital side mirror control device 100 can compare a face angle value O_{Face_yaw} extracted through the face attribute detection module 120 with the angle θ_{Lx}, θ_{Rx}, θ_{Ly}, or θ_{Ry} between the face and each side mirror.

When the difference between the face angle value and the angle between the face and a side mirror falls within a specific range determined in consideration of an error rate, the facial recognition based digital side mirror control device 100 can determine that the driver (USER) is looking at the side mirror 20 or 30.

When it is determined that the driver is looking at the side mirror, the facial recognition based digital side mirror control device 100 can initialize parameters such as the initial face position (0, 0, 0) and the distance of the side mirror from the face position.

From then on, the facial recognition based digital side mirror control device 100 can adjust the viewing angle of the side mirror in response to each time when the driver moves the face position.

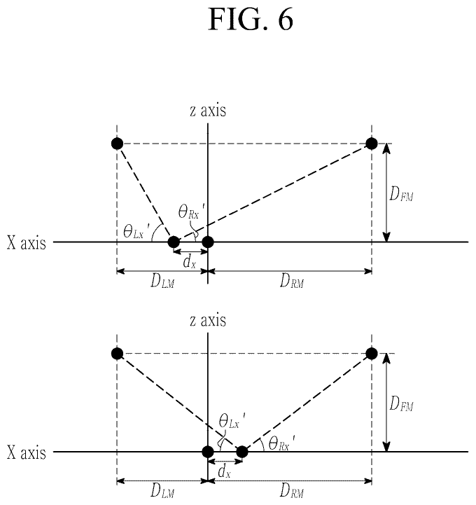

FIGS. 6 to 8 are drawings for explaining an example of an attribute change value extractor.

The attribute change value can be a change value in the angle between the face position of the driver and a side mirror. In other words, the attribute change value can be a changed angle between the face position of the driver and a side mirror. The changed angle can be referred to as a target view estimator (TVE).

In FIG. 6, when the driver moves the face to the left by dx, the facial recognition based digital side mirror control device 100 calculates the changed angle of the side mirror based on the motion, using Expression 1.

$$\text{?}$$

$$\text{?} \text{indicates text missing or illegible when filed}$$

Here, θ_{Lx}′ is the changed angle between the face and the left side mirror, θ_{Rx}′ is the changed angle between the face and the right side mirror, D_{FM} is the vertical distance of each side mirror from the face, D_{LM} is the distance of the left side mirror from the face, and D_{RM} is the distance of the right side mirror from the face.

When the driver moves to the right by dx, the facial recognition based digital side mirror control device 100 calculates the changed angle of each side mirror using Expression 2.

$$\text{?}$$

$$\text{?} \text{indicates text missing or illegible when filed}$$

Here, θ_{Lx}′ is the changed angle between the face and the left side mirror, θ_{Rx}′ is the changed angle between the face and the right side mirror, D_{FM} is the vertical distance of each side mirror from the face, D_{LM} is the distance of the left side mirror from the face, and D_{RM} is the distance of the right side mirror from the face.

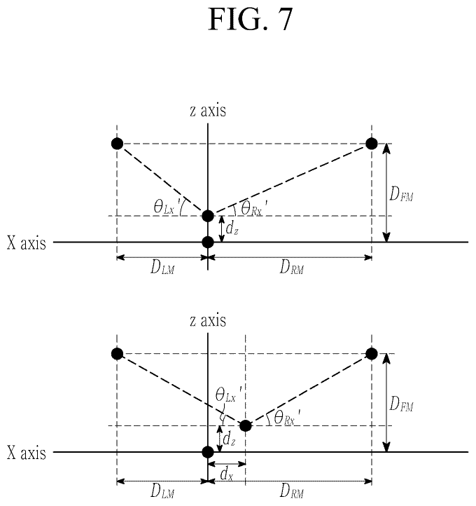

In FIG. 7, when the driver moves forward by dz, the facial recognition based digital side mirror control device 100 calculates the changed angle of each side mirror using Expression 3.

$$\text{?}$$

$$\text{?} \text{indicates text missing or illegible when filed}$$

Here, θ_{Lx}′ is the changed angle between the face and the left side mirror, θ_{Rx}′ is the changed angle between the face and the right side mirror, D_{FM} is the vertical distance of each side mirror from the face, D_{LM} is the distance of the left side mirror from the face, and D_{RM} is the distance of the right side mirror from the face.

When the driver moves right forward by dx and dz, the facial recognition based digital side mirror control device 100 calculates the changed angle of each side mirror using Expression 4.

$$\text{?}$$

$$\text{?} \text{indicates text missing or illegible when filed}$$

Here, θ_{Lx}′ is the changed angle between the face and the left side mirror, θ_{Rx}′ is the changed angle between the face and the right side mirror, D_{FM} is the vertical distance of each side mirror from the face, D_{LM} is the distance of the left side mirror from the face, and D_{RM} is the distance of the right side mirror from the face.

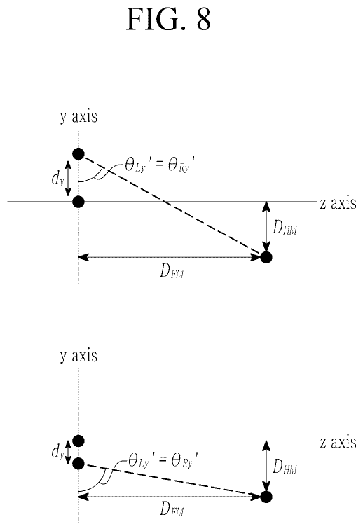

In FIG. 8, when the driver moves the face upward by dy by raising the head, the facial recognition based digital side mirror control device 100 calculates the changed angle of each side mirror using Expression 5.

$$\text{?}$$

$$\text{?} \text{indicates text missing or illegible when filed}$$

Here, θ_{Ly}′ is the changed angle between the face and the left side mirror, θ_{Ry}′ is the changed angle between the face and the right side mirror, D_{FM} is the vertical distance of each side mirror from the face, and D_{HM} is the height of each side mirror from the face.

When the driver moves the face downward by dy by lowering the head, the facial recognition based digital side mirror control device 100 calculates the changed angle of each side mirror using Expression 6.

$$\text{?}$$

$$\text{?} \text{indicates text missing or illegible when filed}$$

Here, θ_{Ly}′ is the changed angle between the face and the left side mirror, θ_{Ry}′ is the changed angle between the face and the right side mirror, D_{FM} is the vertical distance of each side mirror from the face, and D_{HM} is the height of each side mirror from the face.

The facial recognition based digital side mirror control device 100 can calculate the difference between the initial angle of the driver's face and the changed angle based on a motion of the user, using Expression 7.

$$d {θ}_{Lx} = {θ}_{Lx} - {θ}_{Lx}^{′} \qquad [ Expression 7 ]$$

$$d {θ}_{Rx} = {θ}_{Rx} - {θ}_{Rx}^{′}$$

$$d {θ}_{Ly} = {θ}_{Ly} - {θ}_{Ly}^{′}$$

$$d {θ}_{Ry} = {θ}_{Ry} - {θ}_{Ry}^{′}$$

Here, θ_{Lx}′ and θ_{Ly}′ are the changed angles between the face and the left side mirror, θ_{Rx}′ and O_{Ry}′ are the changed angles between the face and the right side mirror, dθ_{Lx} and dθ_{Ly} are the difference between the initial angle between the face and the left side mirror and the changed angle between them, and dθ_{Rx} and dθ_{Ry} are the difference between the initial angle between the face and the right side mirror and the changed angle between them.

The facial recognition based digital side mirror control device 100 can calculate an adjustment value to be reflected in the adjustment of the viewing angle of each side mirror, using Expression 8.

In other words, the facial recognition based digital side mirror control device 100 can calculate adjustment values which are the final outputs, by multiplying the angle differences calculated above by Expression 7 by different weights a_{Lx}, a_{Rx}, a_{Ly}, and a_{Ry}, respectively.

$${weight}_{Lx} = d {θ}_{Lx} * {a}_{Lx} \qquad [ Expression 8 ]$$

$${weight}_{Rx} = d {θ}_{Rx} * {a}_{Rx}$$

$${weight}_{Ly} = d {θ}_{Ly} * {a}_{Ly}$$

$${weight}_{Ry} = d {θ}_{Ry} * {a}_{Ry}$$

$$\text{?}$$

$$\text{?} \text{indicates text missing or illegible when filed}$$

Here, weight_{Lx} and weight_{LY} can be adjustment values which are used to adjust the left side mirror, and weight_{Rx} and weight_{Ry} can be adjustment values which are used to adjust the right side mirror.

Each adjustment value can be a final parameter which is used to control a side mirror.

The facial recognition based digital side mirror control device 100 can set a weight depending on the resolution, viewing direction, and sensitivity of a digital side mirror.

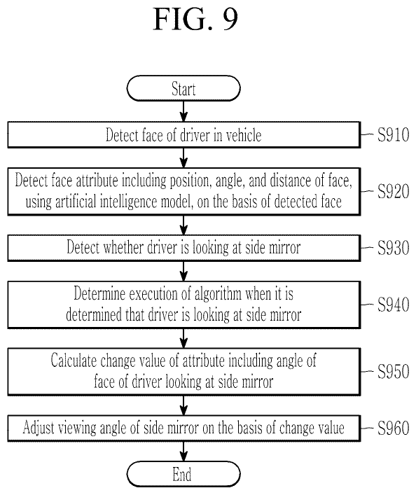

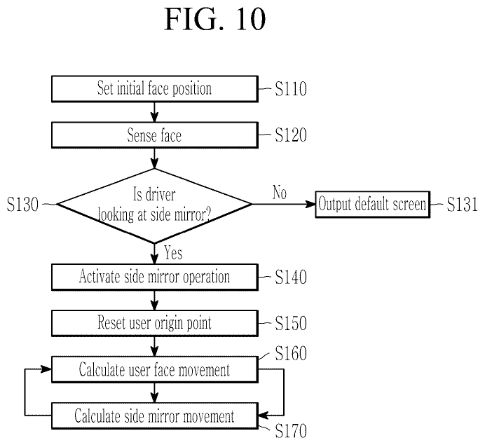

FIGS. 9 and 10 are flow charts illustrating an example of an operation mechanism of a facial recognition based digital side mirror control method. The facial recognition based digital side mirror control method can be performed through the facial recognition based digital side mirror control device 100 of FIG. 2.

In FIG. 9, the facial recognition based digital side mirror control device 100 can detect the face of the driver in the vehicle (STEP S910).

The facial recognition based digital side mirror control device 100 can detect a face attribute including the position and feature of the face and the driver information, using the artificial intelligence model, based on the detected driver's face (STEP S920).

The facial recognition based digital side mirror control device 100 can extract the driver information including the age and gender of the driver, using the trained deep learning model.

The facial recognition based digital side mirror control device 100 extracts the feature vector of the face, using a trained deep learning model.

The facial recognition based digital side mirror control device 100 can calculate the similarity of an extracted feature vector to a feature vector registered in advance for each driver, and identify the driver on the basis of the calculated similarity.

Further, the facial recognition based digital side mirror control device 100 extracts the landmark including the eyes, nose, and mouth of the driver's face, and extracts the face angle on the basis of the extracted landmark.

The facial recognition based digital side mirror control device 100 obtains the image coordinate based position of the face, and extracts the distance between the camera and the face on the basis of the depth of the position.

The facial recognition based digital side mirror control device 100 can detect whether the driver is looking at a side mirror (STEP S930).

When the face angle falls within a specific angle range preset on the basis of the face angle and the side mirror angle of a side mirror, the facial recognition based digital side mirror control device 100 can determine that the driver is looking at the side mirror.

In some examples, the facial recognition based digital side mirror control device 100 can execute the algorithm only when it is determined that the driver is looking at a side mirror (STEP S940).

Here, the algorithm can correspond to a facial recognition based digital side mirror control method.

The facial recognition based digital side mirror control device 100 can calculate a change value of the attribute including the angle of the face of driver looking at the side mirror (STEP S950).

The facial recognition based digital side mirror control device 100 can obtain an angle change value based on the difference between a first angle between the face and the side mirror at the initial position of the face and a second angle between the face and the side mirror at the current position of the face.

The facial recognition based digital side mirror control device 100 can multiply the angle difference by a weight, thereby determining an adjustment value to be applied in the adjustment of the side mirror.

For example, the facial recognition based digital side mirror control device 100 can multiply with different weights depending on a plurality of side mirrors and the angle between each of the plurality of side mirrors and the face.

The facial recognition based digital side mirror control device 100 can determine different weights on the basis of the resolution of each of the plurality of side mirrors and the above-mentioned angle.

The facial recognition based digital side mirror control device 100 can adjust the viewing angle of the side mirror on the basis of the change value (STEP S960).

The facial recognition based digital side mirror control device 100 can process an image of a screen which is displayed on the side mirror on the basis of the attribute change value.

The facial recognition based digital side mirror control device 100 can set side mirror adjustment sensitivity based on the driver information.

The facial recognition based digital side mirror control device 100 can adjust the viewing angle on the basis of the adjustment value and side mirror adjustment sensitivity.

The facial recognition based digital side mirror control device 100 can set the adjustment sensitivity on the basis of sensitivity which the driver has input in advance through the infotainment of the vehicle.

In FIG. 10, the facial recognition based digital side mirror control device 100 can calculate the initial face position of the driver (STEP S110).

Referring to FIG. 4, for example, when it is assumed that D_{FM} is 0.3, D_{HM} is 0.2, D_{RM} is 1.2, and D_{LM} is 0.4, if the initial driver face position is set to (0, 0, 0), the position of the left side mirror and the positioned on the right side mirror are calculated to be (0.4, 0.2, 0.3) and (1.2, 0.2, 0.3), respectively.

In this case, θ_{Lx} can be 36 degrees, θ_{Rx} can be 14 degrees, and θ_{Ly} and θ_{Ry} can be 71.6 degrees.

The facial recognition based digital side mirror control device 100 can sense the driver's face at the initial face position (STEP S120).

The facial recognition based digital side mirror control device 100 can sense the face using various object detection methods.

The facial recognition based digital side mirror control device 100 can determine whether the driver is looking at a side mirror, on the basis of the sensed face (STEP S130).

When the amount of Y-axis rotation of the detected face position is not approximate to predefined angles 90-θ_{Lx} and 90-θ_{Rx}, the facial recognition based digital side mirror control device 100 can determine that the driver is looking forward without looking at the side mirror.

When the amount of Y-axis rotation of the detected face position is the predefined angle 90-θ_{Lx} or 90-θ_{Rx}, for example, when the driver has rotated the face 54 degrees to the left or 76 degrees to the right, the facial recognition based digital side mirror control device 100 can determine that the driver is looking at a side mirror.

When it is determined that the driver is not looking at a side mirror, the facial recognition based digital side mirror control device 100 can output a preset default screen and viewing angle (STEP S131).

When it is determined that the driver is looking at a side mirror, the facial recognition based digital side mirror control device 100 can activate control on the side mirror according to the algorithm (STEP S140).

When the control on the side mirror is activated, the facial recognition based digital side mirror control device 100 can reset the origin point set to the initial face position, to the current user's face position (STEP S150).

The facial recognition based digital side mirror control device 100 can calculate a movement value by tracking the driver's face position (STEP S160).

The facial recognition based digital side mirror control device 100 can calculate a movement value or adjustment value of a side mirror according to the movement of the face position (STEP S170).

For example, it is assumed that the driver is looking at the right side mirror (specifically, the viewer of the right side mirror).

The facial recognition based digital side mirror control device 100 resets the position of the origin point to the current driver's face position. When it is assumed that there is no movement of the driver's head position from the initial position, D_{FM}, D_{HM}, D_{RM}, and D_{LM} can be 0.3, 0.2, 1.2, and 0.4, respectively.

Thereafter, the facial recognition based digital side mirror control device 100 can calculate the face position in real time through face sensing and face position tracking.

For example, when it is assumed that the driver's face position has moved from (0, 0, 0) to (0, 0.1, 0.1) (the driver's face position has moved 0.1 m forward and 0.1 m upward), θ_{Rx}′ and θ_{Ry}′ can be calculated to be 9.5 degrees and 56.3 degrees, respectively.

Further, after obtaining the angle difference between the origin point and the face movement position, the facial recognition based digital side mirror control device 100 can calculate the adjustment value or movement amount of a side mirror by multiplying with a weight.

For example, dθ_{Rx} (=θ_{Rx}−θ_{Rx}′) can be 5.5 (=14−9.5) degrees, and dθ_{Ry} (=θ_{Ry}−θ_{Ry}′) can be 15.2 (=71.5−56.3) degrees.

In an implementation, when a_{Rx} is 10 and a_{Ly} is 5.625, weight_{Rx}(=dθ_{Rx}×a_{Rx}) can be calculated to be 55 (=5.5×10), and weight_{Ry} (=dθ_{Ry}×a_{Ry}) can be calculated to be 85.5152 (=15.2×5.625).

In other words, the facial recognition based digital side mirror control device 100 can calculate 85.5 and 55 (unit pixels) as the adjustment value of the left side mirror and the adjustment value of the right side mirror, respectively, and move the left and right side mirrors by the corresponding adjustment values, respectively.

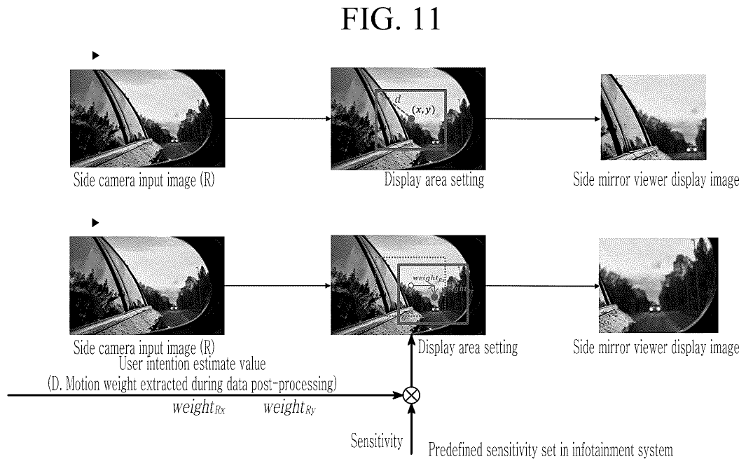

FIG. 11 is a drawing for explaining an example of an image processor.

FIG. 11 is photographs for explaining that a side mirror moves according to the facial recognition based digital side mirror control method.

In FIG. 11, an image which is displayed on a viewer is represented smaller than the viewing angle initially set in a side mirror camera.

In some examples, when the intention of the driver is reflected in the side mirror according to an example implementation, the facial recognition based digital side mirror control device 100 moves the display area (or viewing angle) of the viewer by a calculated weight.

Therefore, the viewer is able to display an image input to the camera as naturally as if looking in a mirror.

For example, the facial recognition based digital side mirror control device 100 can control the screen which is displayed on the viewer, by multiplying a user intention estimate value (the side mirror adjustment value weight_{Rx} or weight_{Ry} by a predefined sensitivity set in an infotainment system.

FIG. 12 is a drawing for explaining an example of a computing device.

Referring to FIG. 12, the facial recognition based digital side mirror control device and method according to the example implementations can be implemented using a computing device 900.

The computing device 900 can include at least one of a processor 910, a memory 930, a user interface input device 940, a user interface output device 950, and a storage device 960 which performs communication through a bus 920. The computing device 900 can also include a network interface 970 that is electrically connected to a network 90. The network interface 970 can transmit or receive signals to or from other entities via the network 90.

The processor 910 can be implemented with various types, such as a micro controller unit (MCU), an application processor (AP), a central processing unit (CPU), a graphic processing unit (GPU), a neutral processing unit (NPU), and the like, and can be an arbitrary semiconductor device that executes instructions stored in the memory 930 or the storage device 960. The processor 910 can be configured to implement the functions and methods described above with reference to FIGS. 1 to 11.

The memory 930 and the storage device 960 can include various forms of volatile or non-volatile storage media. For example, the memory can include a read-only memory (ROM) 931 and a random access memory (RAM) 932. In the present example implementation, the memory 930 can be located inside or outside the processor 910, and the memory 930 can be coupled to the processor 910 through various known means.

In some implementations, at least some components or functions of the facial recognition based digital side mirror control device and method according to the example implementations can be implemented as programs or software which is executed in the computing device 900, and the programs or software can be stored in computer-readable media.

In some implementations, at least some components or functions of the facial recognition based digital side mirror control device and method according to the example implementations can be implemented using hardware or circuits of the computing device 900 or can be implemented with separate hardware or circuits electrically connectable to the computing device 900.

While this disclosure has been described in connection with what is presently considered to be practical example implementations, it is to be understood that the disclosure is not limited to the disclosed implementations. It is intended to cover various modifications and equivalent arrangements included within the spirit and scope of the appended claims.

1-20. (canceled)

21. A side mirror control device based on facial recognition, the side mirror control device comprising:
one or more processors; and
one or more memory devices storing a program code configured to, based on being executed by the one or more processors, cause the side mirror control device to perform operations comprising:
detecting a face of a driver in a vehicle,
detecting a face attribute including a position of the face, a feature of the face, and driver information using an artificial intelligence model,
determining whether the driver is looking at a side mirror of the vehicle, executing an algorithm based on determining that the driver is looking at the side mirror, and
adjusting at least one setting of the side mirror based on an attribute change of the face attribute, the attribute change including a position change of the position of the face of the driver looking at the side mirror.

22. The side mirror control device of claim 21, wherein detecting the face attribute comprises:
extracting the driver information including an age and a gender of the driver, using a trained deep learning model;
extracting a feature vector of the face, using a trained deep learning model;
extracting a landmark including eyes, a nose, and a mouth from information of the face of the driver;
extracting a face angle based on the landmark;
obtaining an image coordinate corresponding to the position of the face; and
extracting a distance between a camera and the face based on a depth of the position of the face.

23. The side mirror control device of claim 22, wherein determining whether the driver is looking at the side mirror of the vehicle comprises:
determining that the driver is looking at the side mirror of the vehicle based on the face angle being within a preset range that is set based on the face angle and a side mirror angle of the side mirror.

24. The side mirror control device of claim 23, wherein adjusting the at least one setting of the side mirror comprises:
extracting an attribute change value including an angle change value of an angle between the face and the side mirror;
processing an image of a screen to be displayed on the side mirror based on the attribute change value; and
setting a side mirror adjustment sensitivity based on the driver information.

25. The side mirror control device of claim 24, wherein extracting the attribute change value comprises:
calculating the angle change value based on an angle difference between (i) a first angle between the face and the side mirror at an initial position of the face and (ii) a second angle between the face and the side mirror at a current position of the face.

26. The side mirror control device of claim 25, wherein extracting the attribute change value further comprises:
determining an adjustment value for an adjustment of the side mirror based on multiplying the angle difference by a weighting factor.

27. The side mirror control device of claim 25, wherein extracting the attribute change value further comprises:
determining a plurality of weighting factors based on (i) a resolution each of a plurality of side mirrors of the vehicle and (ii) an angle of each of the plurality of side mirrors relative to the face; and
determining an adjustment value for an adjustment of each of the plurality of side mirrors based on multiplying the angle difference corresponding to one of the plurality of side mirrors by a corresponding one of the plurality of weighting factors.

28. The side mirror control device of claim 26, wherein adjusting the at least one setting of the side mirror further comprises:
adjusting a viewing angle of the side mirror based on the adjustment value and the side mirror adjustment sensitivity.

29. The side mirror control device of claim 24, wherein setting the side mirror adjustment sensitivity comprises:
setting the side mirror adjustment sensitivity based on a sensitivity input provided through an infotainment system of the vehicle.

30. The side mirror control device of claim 22, wherein detecting the face attribute comprises:
calculating a similarity between (i) the feature vector that is extracted using the trained deep learning model and (ii) one or more feature vectors that are pre-registered for one or more drivers; and
identifying the driver based on the similarity.

31. A side mirror control method based on facial recognition, the side mirror control method being performed by a computing device including a processor and a memory and comprising:
detecting a face of a driver in a vehicle;
detecting a face attribute including a position of the face, a feature of the face, and driver information using an artificial intelligence model;
determining whether the driver is looking at a side mirror of the vehicle,
executing an algorithm based on determining that the driver is looking at the side mirror; and
adjusting at least one setting of the side mirror based on an attribute change of the face attribute, the attribute change including a position change of the position of the face of the driver looking at the side mirror.

32. The side mirror control method of claim 31, wherein detecting the face attribute comprises:
extracting the driver information including an age and a gender of the driver, using a trained deep learning model;
extracting a feature vector of the face, using a trained deep learning model;
extracting a landmark including eyes, a nose, and a mouth from information of the face of the driver;
extracting a face angle based on the landmark;
obtaining an image coordinate corresponding to the position of the face; and
extracting a distance between a camera and the face based on a depth of the position of the face.

33. The side mirror control method of claim 32, wherein determining whether the driver is looking at the side mirror of the vehicle comprises:
determining that the driver is looking at the side mirror of the vehicle based on the face angle being within a preset range that is set based on the face angle and a side mirror angle of the side mirror.

34. The side mirror control method of claim 33, wherein adjusting the at least one setting of the side mirror comprises:
extracting an attribute change value including an angle change value of an angle between the face and the side mirror;
processing an image of a screen to be displayed on the side mirror based on the attribute change value; and
setting a side mirror adjustment sensitivity based on the driver information.

35. The side mirror control method of claim 34, wherein extracting the attribute change value comprises:
calculating the angle change value based on an angle difference between (i) a first angle between the face and the side mirror at an initial position of the face and (ii) a second angle between the face and the side mirror at a current position of the face.

36. The side mirror control method of claim 35, wherein extracting the attribute change value further comprises:
determining an adjustment value for an adjustment of the side mirror based on multiplying the angle difference by a weighting factor.

37. The side mirror control method of claim 35, wherein extracting the attribute change value further comprises:
determining a plurality of weighting factors based on (i) a resolution each of a plurality of side mirrors of the vehicle and (ii) an angle of each of the plurality of side mirrors relative to the face; and
determining an adjustment value for an adjustment of each of the plurality of side mirrors based on multiplying the angle difference corresponding to one of the plurality of side mirrors by a corresponding one of the plurality of weighting factors.

38. The side mirror control method of claim 36, wherein adjusting the at least one setting of the side mirror further comprises:
adjusting a viewing angle of the side mirror based on the adjustment value and the side mirror adjustment sensitivity.

39. The side mirror control method of claim 34, wherein setting the side mirror adjustment sensitivity comprises:
setting the side mirror adjustment sensitivity based on a sensitivity input provided through an infotainment system of the vehicle.

40. The side mirror control method of claim 32, wherein detecting the face attribute comprises:
calculating a similarity between (i) the feature vector that is extracted using the trained deep learning model and (ii) one or more feature vectors that are pre-registered for one or more drivers; and
identifying the driver based on the similarity.
